(19) United States
(12) Patent Application Publication
(10) Pub. No.: US 2008/0089325 A1
(43) Pub. Date: Apr. 17, 2008

(54) AUDIO QUALITY-BASED CONTINUITY SWITCHING SYSTEM AND METHOD

(75) Inventor: Wai Kong Sung, Tai Koo Shing (HK)

Correspondence Address: MICHAEL BEST & FRIEDRICH LLP, 100 E WISCONSIN AVENUE, Suite 3300, MILWAUKEE, WI, 53202, US

(73) Assignee: E28 Limited

(21) Appl. No.: 11/549,945

(22) Filed: Oct. 16, 2006

Related U.S. Application Data
(60) Provisional application No. 60/851,528, filed on Oct. 14, 2006.

(51) Int. Cl. H04L 12/28

(52) U.S. Cl. 370/389

(57) ABSTRACT

A method of activating a handover of signals representing an audio between an audio sending end and an audio receiving end associated with one of first and second networks. The method includes determining a quality of the audio at the receiving end, and determining a location of the receiving end between the first and second networks. The method also includes generating one of an intermediate signal when the location of the receiving end is on the first network, and a notification signal when the location of the receiving end is on the second network, and sending the notification signal to the audio sending end.

### BACKGROUND

Embodiments of the present invention relate to audio-quality based, voice call continuity in a network.

Voice information or calls can be carried on a variety of different networks. The telephone network in the United States is often referred to as the pain old telephone service (“POTS”) network and is a circuit-switched network. The relatively new technology of voice over Internet protocol (“VoIP”) is used to send voice calls over the Internet, which is a packet-switched network. Voice call continuity (“VCC”) is generally a mechanism for switching a call (e.g., a telephone call) between a packet-switched (“PS”) network and a circuit-switched (“CS”) network. VCC systems typically include VCC servers running on one or more networks. In addition to such servers, VCC systems typically include client software that run on handsets. The handsets can be located at a sending end, a receiving end, or both ends of a network.

As noted, VCC mechanisms are concerned with the continuity of voice calls between networks. However, continuity is usually the only factor or element of network communication that is addressed by VCC mechanisms. For example, audio quality is generally not something that is addressed in a VCC system. Thus, while current VCC implementations can maintain voice call continuity, audio quality of the call is often overlooked or ignored. As a result, voice calls can sometimes be incomprehensible at one or both of the sending and receiving ends.

Some audio degradation is generated as a direct result of the basic architecture of PS networks. In a typical PS network, audio streams from a sending end or device are divided into a plurality of packets. The packets then travel to a receiving end or device through different routes and via a plurality of nodes. Network characteristics such as network latency and packet loss typically lead to degradation in the quality of the audio signal generated from the audio streams received at the receiving device. If latency, packet loss, or other network interference becomes too great, the audio signal can degrade to a point where communication is difficult or impossible because the voice call is difficult or impossible for a person to understand.

Different methods are used at sending ends to trigger a VCC handover from the one type of network to another. These methods include a manual choice or selection by a user and automated selection based on a detected signal strength. One way of detecting signal strength is to use a wireless local area network (“WLAN”) received signal strength indication (“RSSI”). However, regardless of what mechanism is used to trigger or initiate the VCC handover, the handover is performed regardless of whether the quality of the audio at the receiving end is acceptable or not.

### SUMMARY

The present invention provides a method of improving audio quality in a network switching setting. In one embodiment, the method uses an audio receiving end to trigger an audio sending end to perform a handover from a PS network to a CS network to improve audio quality. For example, the method allows a user at the receiving end to manually trigger a handover if the user finds the audio quality is unacceptable, or if the sending end is currently in the PS network. For another example, when the receiving end is also in the PS network, the method can also automatically trigger a handover. Once the sending end receives a trigger, if the sending end is in the PS network, the sending end can perform a PS to CS handover based on mechanisms described in the 3GPP Specification TR 23.806.

In one embodiment, the invention provides a method of activating a handover of signals between a PS network and a CS network. The method includes locating a receiving end in one of the PS network and CS network, prompting a user to activate a handover when the receiving end is in the CS network, and generating a notification from the receiving end to a sending end when the receiving end is in the PS network.

In another embodiment, the invention provides a method of activating a handover of signals between a PS network and a CS network. The method includes locating a receiving end in one of the PS network and CS network. The method also includes generating a notification from the receiving end to a sending end when the receiving end is in the PS network, and waiting for an acknowledgement signal at the receiving end from the sending end.

In another embodiment, the invention provides a method of activating a handover of signals between a PS network and a CS network via a server. The method includes locating a receiving end in one of the PS network and CS network. The method also includes generating a notification from the receiving end to a sending end when the receiving end is in the PS network, and notifying the server that the sending end has received the notification.

In another embodiment, the invention provides a method of activating a handover of signals representing an audio between an audio sending end and an audio receiving end associated with one of first and second networks. The method includes determining a quality of the audio at the receiving end, and determining a location of the receiving end between the first and second networks. The method also includes generating one of an intermediate signal when the location of the receiving end is on the first network, and a notification signal when the location of the receiving end is on the second network, and sending the notification signal to the audio sending end.

In another embodiment, the invention provides a method of activating a handover of signals representing an audio at an audio sending end associated with a first network. The method includes receiving an audio signal at an audio receiving end, and determining a quality of the audio at the receiving end. The method also includes determining an audio receiving end network associated with the receiving end, comparing the audio receiving end network with the first network, generating a notification signal when the network is the first network, and sending the notification signal to the audio sending end

In another embodiment, the invention provides a method of activating a handover of signals representing an audio stream traveling from a first end associated with a first network to a second end associated with a second network. The method includes determining a type of network associated with the second end, and determining at least one of a statistical characteristic of the audio when the type of network is the first network. The method also includes comparing the statistical characteristics of the audio with a plurality of statistical thresholds, generating a notification signal when the type of network is the first network, and sending the notification signal to the first end.

Other aspects of the invention will become apparent by consideration of the detailed description and accompanying drawings.

### BRIEF DESCRIPTION OF THE DRAWINGS

FIG. 1 illustrates a PS-CS handover trigger process originated from an audio receiving end in a PS network.

FIG. 2 illustrates a PS-CS handover trigger process originated from an audio receiving end in a CS network.

FIG. 3 is a flow chart illustrating a handover triggering process in an audio receiving end.

FIG. 4 is a continuation of the flow chart in FIG. 3.

FIG. 5 is a flow chart illustrating a handover triggering process in an audio sending end.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting.

The present invention provides an option for an audio receiving end to trigger an audio sending end to perform a handover from a PS network to a CS network for improving audio quality. In some embodiments, triggers can be manually generated by a user at the audio receiving end if the user finds the audio quality is unacceptable. Triggers can also be automatically generated when the receiving end is in the PS network. In some cases, if the packet loss is over a certain threshold, the audio quality can be degraded. When the audio sending end receives a trigger while on the PS network, the sending end can perform a PS-to-CS handover based on mechanisms described in the 3GPP Specification TR 23.806.

Triggers from the audio receiving end can also be implemented as a notification signal or message as described in the IETF RFC 3428. Although the mechanisms described in the 3GPP Specification TR 23.806 use protocols from IETF RFC3261 session initiated protocol (“SIP”), the present invention is not limited to SIP protocol. If the audio receiving end is directly on the PS network, the notification signal or message can be sent directly from the audio receiving end terminal. If the audio receiving end is on the CS network, a SIP proxy can be used and the audio receiving end can send a trigger via the SIP proxy by using a short message service (“SMS”) described in GSM 03.40 or a special dial-tone-multiple-frequency (“DTMF”).

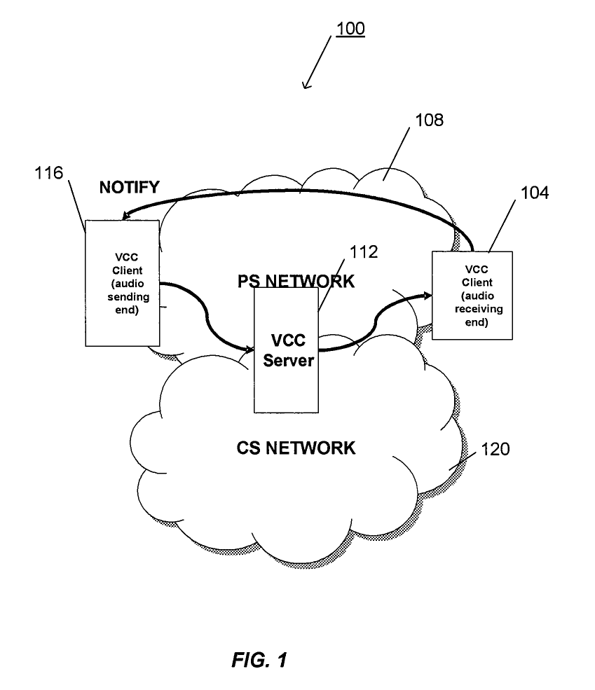

FIG. 1 illustrates a PS-CS handover trigger process in a network system 100 originated from an audio receiving end 104 in a PS network 108. A voice-call-continuity server 112 receives signals from an audio sending end 116, and transfers the signals to the audio receiving end 104. In the embodiment shown, both the sending and receiving ends 116, 104 are in the PS network 108, rather than in a CS network 120. In such cases, the audio receiving end 104 sends a notification signal or message directly to the sending end 116. In this way, the receiving end 104 can trigger a PS-to-CS network handover at the sending end 116.

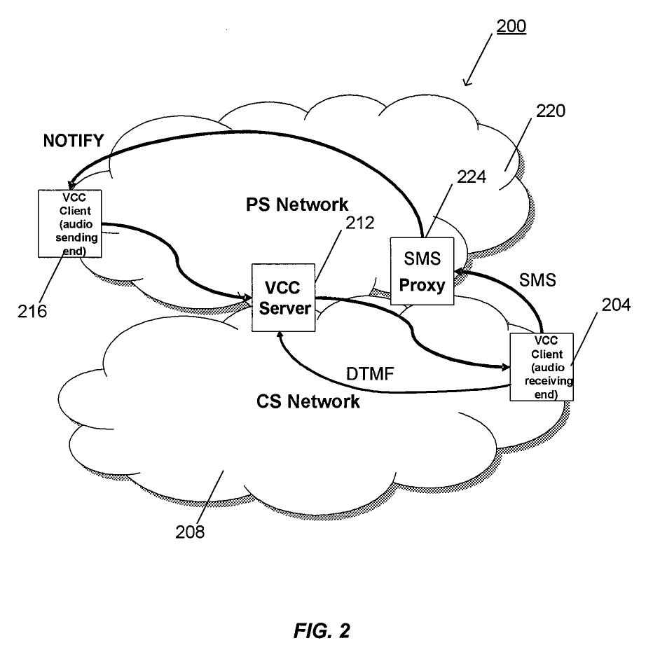

FIG. 2 illustrates a second PS-CS handover trigger process in a network system 200 originated from an audio receiving end 204 in a CS network 208. In the embodiment shown, a VCC server 212 transfers signals from an audio sending end 216 to the receiving end 204. The audio sending end 216 is shown as being in a PS network 220. In such cases, the PS-CS handover trigger process shown in FIG. 2 uses a short message service (“SMS”) proxy 224 to access both the CS and PS networks 208, 220. There are a plurality of techniques to trigger the PS-CS handover trigger process 200. For example, for out-of-band signaling, the receiving end sends a trigger signal to the SMS proxy 224 using techniques such as SMS. For in-band signaling, the receiving end sends a notification signal or message to the VCC server 212 using techniques such as dual-tone-multiple-frequency (“DTMF”) techniques. When the audio sending end 216 has received the trigger signal or message, the audio sending end 216 will arrange to perform a PS-CS handover.

The following discussion assumes audio streams representing a voice call from an audio sending end are divided into a plurality of packets. The packets travel to an audio receiving end via a VCC server. The packets are then transformed to audio streams at the receiving end. Additionally, the audio streams received at the receiving end generally have low quality due to different network characteristics.

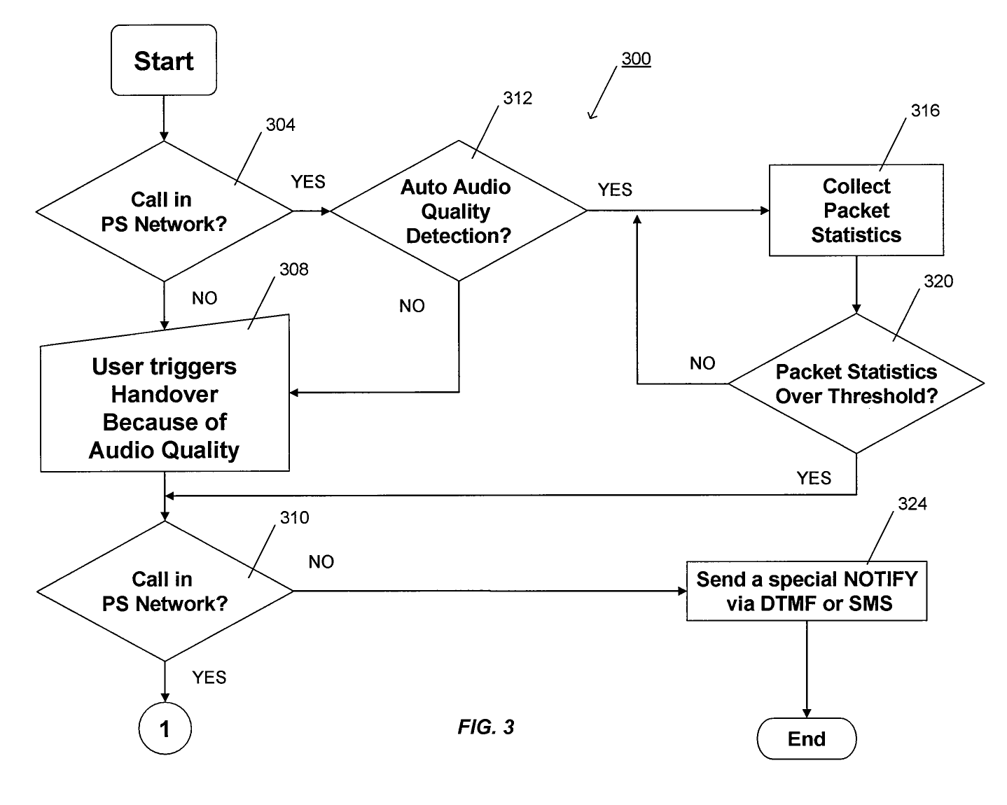

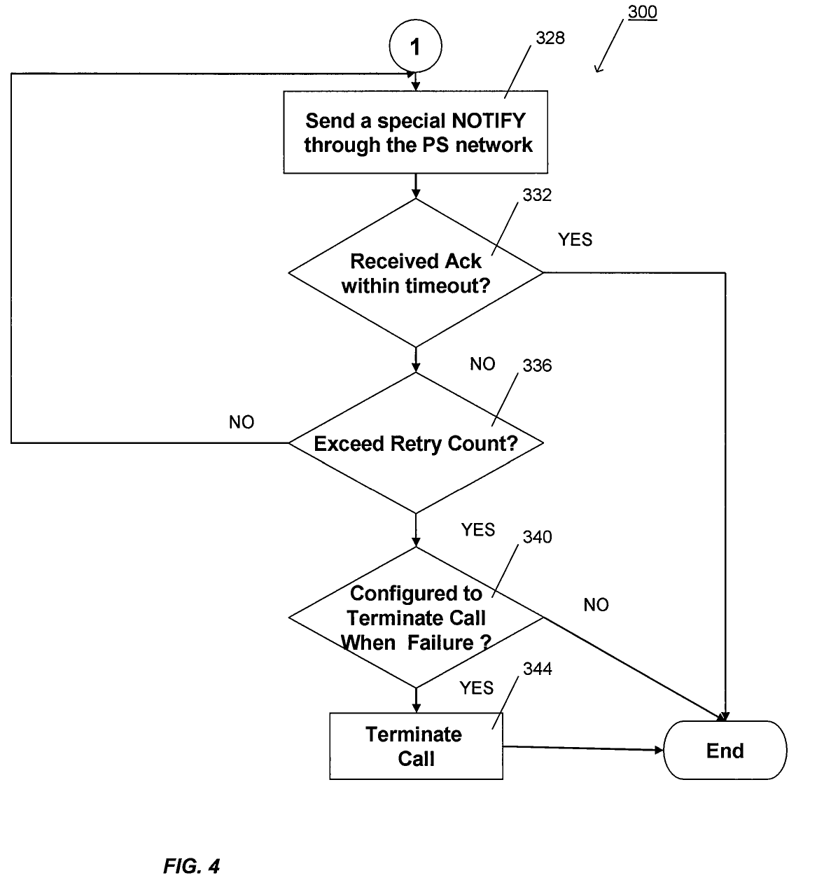

FIG. 3 and FIG. 4 show portions of a flow chart illustrating a handover triggering process 300 originated from the audio receiving end. At block 304, the handover triggering process 300 determines a network location of the audio receiving end. In this way, the handover triggering process 300 can adjust the audio quality perceived at the audio receiving end according to the network location of the audio receiving end. If the handover triggering process 300 determines that the audio receiving end is on a CS network at block 304, the handover triggering process 300 proceeds to block 308. In some embodiments, the handover triggering process 300 also assumes that the receiving end is on the CS network, when the receiving end is not on the PS network as determined at block 304. At block 308, the handover triggering process 300 relies on a user on the receiving end to determine the audio quality of the voice call. In such cases, if the user on the receiving end determines that the audio quality is poor, or starts to deteriorate, the handover triggering process 300 prompts the user on the receiving end to manually notify a PS-to-CS handover trigger through a graphical interface at the receiving end. The handover triggering process then proceeds to block 310.

Referring back to block 304, if the handover triggering process 300 determines that the audio receiving end is on the PS network, the handover triggering process 300 proceeds to determine if an automatic audio quality detection process has been activated or enabled at block 312. If the handover triggering process 300 determines that the automatic audio quality detection process has not been activated or enabled at block 312, the handover triggering process 300 proceeds to block 308. However, if the handover triggering process 300 determines that the automatic audio quality detection process has been activated or enabled at block 312, the handover triggering process 300 proceeds to collect statistical characteristics of the packets such as packet loss and network latency, at block 316. The handover triggering process 300 then compares these statistical characteristics with a plurality of corresponding statistical thresholds at block 320. If the handover triggering process 300 determines that these statistical characteristics are within the corresponding thresholds at block 320, the handover triggering process 300 continues to collect packet statistics.

Otherwise, if the handover triggering process 300 determines that these statistical characteristics exceed the corresponding thresholds, as determined at block 320, the handover triggering process 300 proceeds to determine if the receiving end remains on the PS network at block 310. If the handover triggering process 300 determines that the receiving end is no longer on the PS network, as determined at block 310 and as shown in FIG. 2, the handover triggering process 300 proceeds to trigger the PS-to-CS handover with techniques such as in-band signaling and out-of-band signaling at block 324. In some embodiments, for the in-band signaling in the VCC environment, the handover triggering process 300 uses a dual tone multi-frequency (“DTMF”) detection at the VCC server to send out a notification signal or message of a PS-to-CS handover trigger to the audio sending end through the PS network. In some embodiments, for the out-of-band signaling in the VCC environment, the handover triggering process 300 uses a short message service (“SMS”) proxy on the PS network to relay the notification signal or message to the audio sending end to trigger the PS-to-CS handover. The handover triggering process 300 terminates thereafter.

Referring back to block 310, if the handover triggering process 300 determines that the receiving end is on the PS network, such as shown in FIG. 1, the handover triggering process 300 proceeds to send a notification signal or message through the PS network to trigger the PS-to-CS handover at the audio sending end at block 328. In some embodiments, the notification signal or message can be implemented with a SIP message such as NOTIFY if SIP has been incorporated in the VCC server. It should be appreciated that other communication signaling protocol can be used to send the notification signal or message to the audio sending end via the PS network.

Once the notification is sent out, the audio receiving end waits for or expects an acknowledgement signal or message from the audio sending end to complete the handover triggering process 300. In a SIP implementation, the acknowledgement signal or message is a 200 status code. At block 332, the handover triggering process 300 starts a timer at the receiving end, and determines if the receiving end has received the acknowledgement signal or message with a time set by the timer. If the handover triggering process 300 determines that the receiving end has received the acknowledgement signal or message at block 332 on or before the timer expires, the handover triggering process 300 terminates. However, if the handover triggering process 300 determines that the receiving end has not received the acknowledgement signal or message at block 332 before the timer expires, the handover triggering process 300 increments a retry counter, and determines if the retry counter has exceeded a counter threshold at block 336. If the handover triggering process 300 determines that the retry counter has not exceeded a counter threshold at block 336, the handover triggering process 300 resets the timer, and resends the notification message or signal as described at block 328. However, the handover triggering process 300 determines that the retry counter has exceeded a counter threshold at block 336, the handover triggering process 300 proceeds to block 340.

At block 340, the handover triggering process 300 determines if the receiving end has been configured to terminate the voice call when a network failure occurs. When the handover triggering process 300 determines that the receiving end has not been configured to terminate the voice call when a network failure occurs, the handover triggering process 300 terminates. However, when the handover triggering process 300 determines that the receiving end has been configured to terminate the voice call when a network failure occurs, the handover triggering process 300 terminates the voice call at block 344, and terminates thereafter.

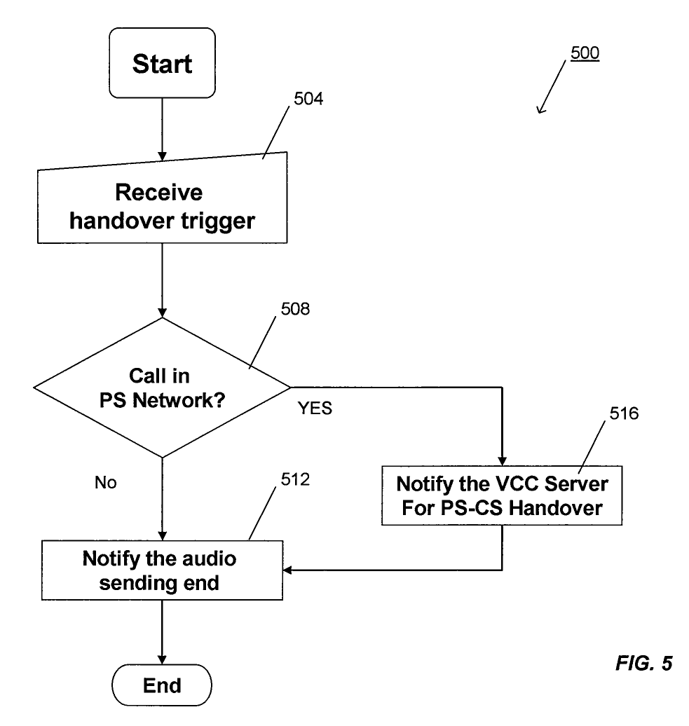

FIG. 5 is a flow chart illustrating a second handover triggering process 500 originated from the audio sending end. At block 504, the audio sending end waits for or expects to receive a notification message or signal as described with respect to the handover triggering process 300. Upon receiving the notification of handover trigger, the second handover triggering process 500 determines if the voice call is on the PS network at block 508. If the second handover triggering process 500 determines that the voice call is on the CS network (rather than on the PS network) at block 508, the second handover triggering process 500 sends a notification signal to notify the audio sending end that a handover is unnecessary and that an acknowledgement signal is necessary at block 512. In such cases, the audio sending end sends the acknowledgement signal to the audio receiving end via the VCC server or the SMS proxy.

However, if the second handover triggering process 500 determines that the voice call is on the PS network at block 508, the second handover triggering process 500 proceeds to block 516. Particularly, the second handover triggering process 500 sends a mobile initiated handover trigger to the VCC server as shown at block 516. In such cases, the second handover triggering process 500 acknowledges the receipt of a trigger message or signal notification by sending an acknowledgement signal back to the receiving end. When SIP is incorporated in the VCC server, the acknowledgement signal is a 200 status code.

Various features and advantages of the invention are set forth in the following claims.

1. A method of activating a handover of signals representing an audio between an audio sending end and an audio receiving end associated with one of first and second networks, the method comprising:
determining a quality of the audio at the receiving end;
determining a location of the receiving end between the first and second networks;
generating one of an intermediate signal when the location of the receiving end is on the first network, and a notification signal when the location of the receiving end is on the second network; and
sending the notification signal to the audio sending end.

2. The method of claim 1, further comprising sending an acknowledgment signal from the audio sending end to the audio receiving end indicating a receipt of the notification signal.

3. The method of claim 1, wherein determining an audio quality at the receiving end comprises manually determining the audio quality by a user.

4. The method of claim 1, wherein determining an audio quality at the receiving end comprises:
determining at least one of a statistical characteristic of the audio; and
comparing the statistical characteristics of the audio with a plurality of statistical thresholds.

5. The method of claim 4, wherein determining at least one of a statistical characteristic comprises collecting a plurality of packet loss statistics.

6. The method of claim 1, wherein sending the notification signal comprises sending the notification signal from the receiving end to the audio sending end.

7. The method of claim 1, wherein the intermediate signal comprises one of an in-band signal and an out-of-band signal, the method further comprising:
sending the in-band signal from the receiving end through a proxy to the audio sending end; and
sending the out-of-band signal from the receiving end to a server accessible by both the first and second networks.

8. A method of activating a handover of signals representing an audio at an audio sending end associated with a first network, the method comprising:
receiving an audio signal at an audio receiving end;
determining a quality of the audio at the receiving end;
determining an audio receiving end network associated with the receiving end;
comparing the audio receiving end network with the first network;
generating a notification signal when the network is the first network; and
sending the notification signal to the audio sending end.

9. The method of claim 8, further comprising sending an acknowledgment signal from the audio sending end to the audio receiving end indicating a receipt of the notification signal.

10. The method of claim 8, wherein determining a quality at the receiving end comprises manually determining the audio quality by a user.

11. The method of claim 8, wherein determining a quality at the receiving end comprises:
determining at least one of a statistical characteristic of the audio; and
comparing the statistical characteristics of the audio with a plurality of statistical thresholds.

12. The method of claim 11, wherein determining at least one of a statistical characteristic comprises collecting a plurality of packet loss statistics.

13. The method of claim 8, wherein sending the notification signal comprises sending the notification signal from the receiving end to the audio sending end.

14. The method of claim 8, wherein determining an audio receiving end network associated with the receiving end comprises determining if the audio receiving end network associated comprises a PS network.

15. A method of activating a handover of signals representing an audio stream traveling from a first end associated with a first network to a second end associated with a second network, the method comprising:
determining a type of network associated with the second end;
determining at least one of a statistical characteristic of the audio when the type of network is the first network,
comparing the statistical characteristics of the audio with a plurality of statistical thresholds;
generating a notification signal when the type of network is the first network; and
sending the notification signal to the first end.

16. The method of claim 15, wherein determining at least one of a statistical characteristic comprises collecting a plurality of packet loss statistics at the second end.

17. The method of claim 15, wherein sending the notification signal comprises sending the notification signal from the second end to the first end.

18. The method of claim 15, wherein determining a type of network associated with the second end comprises determining if the second network associated comprises a PS network.

19. The method of claim 15, further comprising sending an acknowledgment signal from the first end to the second end indicating a receipt of the notification signal.

20. The method of claim 19, further comprising timing a receipt of an acknowledgment signal at the second end.
